(19) United States
(12) Patent Application Publication
(10) Pub. No.: US 2020/0356037 A1
(43) Pub. Date: Nov. 12, 2020

(54) SHEET DISTINCTION DEVICE AND IMAGE FORMING APPARATUS

(71) Applicant: Konica Minolta, Inc., Tokyo (JP)

(72) Inventors: Kazutoshi YOSHIMURA, Hino-shi (JP); Satoshi OGATA, Hachioji-shi (JP); Yumiko IZUMIYA, Hachioji-shi (JP)

(21) Appl. No.: 16/868,915

(22) Filed: May 7, 2020

(30) Foreign Application Priority Data
May 8, 2019 (JP) 2019-087980

(51) Int. Cl. G03G 15/00

(52) U.S. Cl. CPC G03G 15/5029

(57) ABSTRACT

A sheet distinction device includes a slot, a detector, a presser, a measurer, a calculator, and an operation controller. A sheet is inserted into the slot. The detector detects that the sheet has reached a detection position of the slot. The presser moves the sheet in a direction perpendicular to an insertion direction of the sheet to press a surface of the sheet against a measurement surface of the measurer. The measurer measures physical properties of the sheet. The calculator calculates an information value indicating time taken to insert the sheet. The operation controller controls operation start time and operation speed of the presser in accordance with the information value calculated by the calculator.

### CROSS REFERENCE TO RELATED APPLICATIONS

The present invention claims priority under 35 U.S.C. § 119 to Japanese Application No. 2019-087980 filed May 8, 2019, the entire content of which is incorporated herein by reference.

### BACKGROUND

### Technological Field

The present invention relates to a sheet distinction device and an image forming apparatus.

### Description of the Related Art

Various types of sheets are used for forming an image in an image forming apparatus. They are different in specifications such as basis weight and thickness. In order to form a high-quality image, conditions of each sheet such as a type of sheet must be set for an image forming apparatus. Incorrect setting of the conditions may spoil paper.

Generally, a user often sets a type of sheet by himself for an image forming apparatus to form an image. The user needs to determine the type of sheet as accurately as possible.

A known sheet distinction device determines a type of sheet from optical information such as an amount of light reflected from a sheet after the sheet is irradiated with light. Specifically, for example, JP 2017-95197A discloses a sheet distinction device. According to this device, a sheet is inserted between a sheet presser and a sheet table. The sheet presser and the sheet table hold the sheet, and the sheet presser moves. Thus, the sheet and the sheet table move relative to a detection sensor so that information of the sheet is obtained.

However, inserting operation of a sheet varies from user to user. According to the sheet distinction device in JP 2017-95197A, condition of a sheet when detected is not constant in some cases such as a case in which the sheet is not put at a normal position. This decreases accuracy in measurement. On the other hand, if a user is forced to carefully insert a sheet to put the sheet at a normal position, work efficiency decreases.

### SUMMARY

An object of the present invention is to provide a sheet distinction device and an image forming apparatus that achieves stable accuracy in measurement without decreasing work efficiency.

To achieve at least one of the abovementioned objects, according to an aspect of the present invention, a sheet distinction device includes:
a slot into which a sheet is inserted;
a detector that detects that the sheet has reached a detection position of the slot;
a measurer that measures physical properties of the sheet that has reached the detection position of the slot;
a presser that moves the sheet in a direction perpendicular to an insertion direction of the sheet to press a surface of the sheet against a measurement surface of the measurer after the detector detects that the sheet has reached the detection position of the slot;
a calculator that calculates an information value indicating time taken to insert the sheet from a predetermined position of the slot to the detection position; and
an operation controller that controls operation start time and operation speed of the presser in accordance with the information value calculated by the calculator.

According to another aspect of the present invention, an image forming apparatus includes the sheet distinction device.

The present invention achieves stable accuracy in measurement without decreasing work efficiency.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is an external view of a sheet distinction device.

FIG. 2 is a cross-sectional view in II-II line of FIG. 1.

FIG. 3 is a block diagram schematically showing configuration of a control system in the sheet distinction device.

FIG. 4 is a flowchart showing sheet distinction processing.

FIG. 5 illustrates a method for setting an operation start time.

FIG. 6 illustrates a method for setting an operation start time.

### DETAILED DESCRIPTION OF EMBODIMENTS

Hereinafter, one or more embodiments of the present invention will be described with reference to the drawings. However, the scope of the invention is not limited to examples shown in the drawings.

### Sheet Distinction Device

First, configuration of a sheet distinction device 100 according to an embodiment will be described.

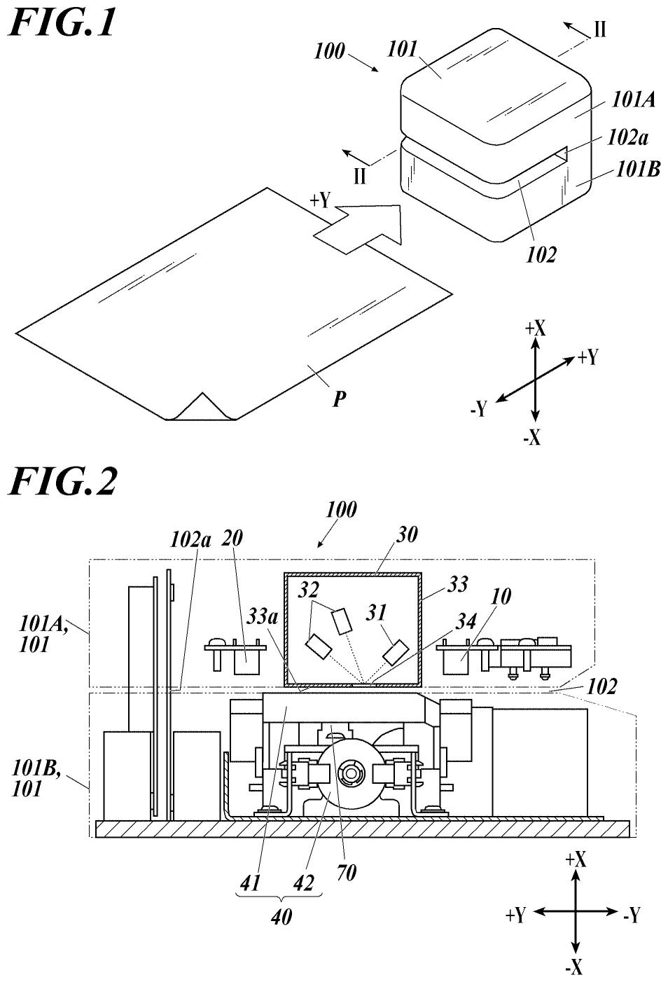

FIG. 1 is an external view of the sheet distinction device 100.

As shown in FIG. 1, the sheet distinction device 100 includes a case 101 that forms the contour of the sheet distinction device 100. On one side of the case 101, a slot 102 into/from which a sheet P is inserted/ejected is formed.

In the following description, the vertical direction of the case 101 is referred to as “X direction”. The upward direction is referred to as “+X direction”, and the downward direction is referred to as “−X direction”. Also, the insertion-ejection direction of a sheet P with respect to the slot 102 is referred to as “Y direction”. The insertion direction is referred to as “+Y direction”, and the ejection direction is referred to as “−Y direction”.

The case 101 includes an upper case portion 101A above the slot 102 and a lower case portion 101B below the slot 102.

The slot 102 is a gap formed between the upper case portion 101A and the lower case portion 101B. An end face 102a is provided deep in the slot 102. An edge of the inserted sheet P is stopped by being brought into contact with the end face 102a.

A user inserts a sheet P horizontally into the slot 102 until it touches the end face 102a deep in the slot 102. A measurer 30 (see FIG. 2) of the sheet distinction device 100 determines the type of the sheet P.

FIG. 2 is a cross-sectional view in II-II line of FIG. 1.

As shown in FIG. 2, the sheet distinction device 100 includes, for example, a first detector 10, a second detector 20, the measurer 30, and a table 40.

Specifically, in the upper case portion 101A, the first detector 10, the measurer 30, and the second detector 20 align in this order along the insertion direction (+Y direction) of a sheet P.

In the lower case portion 101B, a table 40 is provided at a position opposite to the first detector 10, the measurer 30, and the second detector 20

The first detector 10 is positioned around an entrance of the slot 102, i.e., upstream from the measurer 30 in the insertion direction. The first detector 10 detects passage of a sheet P.

The second detector 20 is positioned around the end face 102a in the slot 102, i.e., downstream from the measurer 30 in the insertion direction. The second detector 20 detects passage of a sheet P.

As the first detector 10 and the second detector 20, for example, photo sensors such as a reflective photo sensor and a transmission type photo sensor may be used.

The measurer 30 includes, for example, one light emitter 31, two light receivers 32, and a housing 33 that accommodates them.

An opening 34 facing the slot 102 is formed in the lower surface 33a of the housing 33. The light emitter 31 emits light toward a sheet P inserted into the slot 102. The light receivers 32 receive light reflected from the sheet P.

In the measurer 30, the light emitter 31 emits light to the sheet P through the opening 34. The light is reflected on the sheet P and is received by the light receivers 32 through the opening 34. Thus the type of the sheet P is determined.

Specifically, light reflected from a sheet P is classified into reflected light that is specularly reflected (specularly reflected light) and reflected light that is diffusely reflected (diffuse reflected light).

A type of sheet P is determined based on an amount of a specific wavelength component in each light component of specularly reflected light and diffuse reflected light. The type may be determined based not on a specific wavelength component but on an amount of received light. Accuracy in distinction is higher in a case of using both the specularly reflected light and diffuse reflected light than in a case of using only one of specularly reflected light and diffuse reflected light.

The table 40 includes a support plate 41 and an elevator 42 that raises and lowers the support plate 41. The support plate 41 supports, from below, a sheet P inserted into the slot 102.

The elevator 42 includes, for example, a drive such as a motor. The elevator 42 performs press operation under control of the controller 51. In the press operation, the elevator 42 lifts support plate 41 from below to press the sheet P against a measurement surface (the lower surface 33a of the housing 33) of the measurer 30.

The support plate 41 and the elevator 42 function as a presser that performs the press operation.

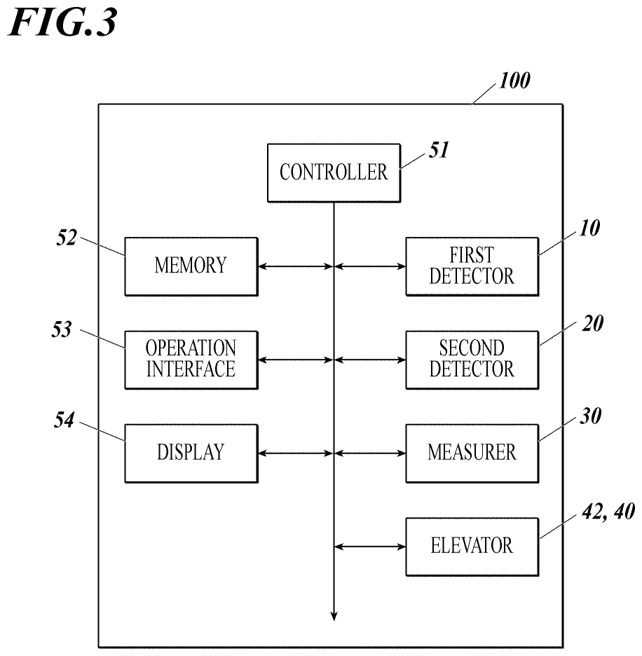

FIG. 3 is a block diagram schematically showing configuration of a control system of the sheet distinction device 100.

As shown in FIG. 3, the sheet distinction device 100 includes a controller 51, a memory 52, an operation interface 53, and a display 54 in addition to the first detector 10, the second detector 20, the measurer 30, and the table 40.

The controller 51 includes a CPU (Central Processing Unit) and a RAM (Random Access Memory). The CPU of the controller 51 reads various programs such as system programs and processing programs stored in the memory 52. The CPU develops them in the RAM and performs various processing according to the developed programs.

The memory 52 stores programs to be executed by the controller 51, setting data to be used in the programs, etc. The memory 52 is constituted by, for example, a non-volatile semiconductor memory. The memory may include a RAM which temporarily stores and processes a part of data.

The operation interface 53 includes various switches and various function buttons. The operation interface 53 receives various operations input by a user and outputs operation signals to the controller 51.

The display 54 includes, for example, an LCD (Liquid Crystal Display). The display 54 performs displaying according to display signals input from the controller 51.

The sheet distinction device 100 may be installed, for example, in image forming apparatuses (printers, copiers, etc.) of electrophotographic processing technologies.

In such a case, the controller 51, the memory 52, the operation interface 53, and the display 54 may be constituted by a controller, a memory, an operation interface, and a display of an image forming apparatus.

### Sheet Distinction Processing

Next, sheet distinction processing performed by the sheet distinction device 100 according to the embodiment will be described.

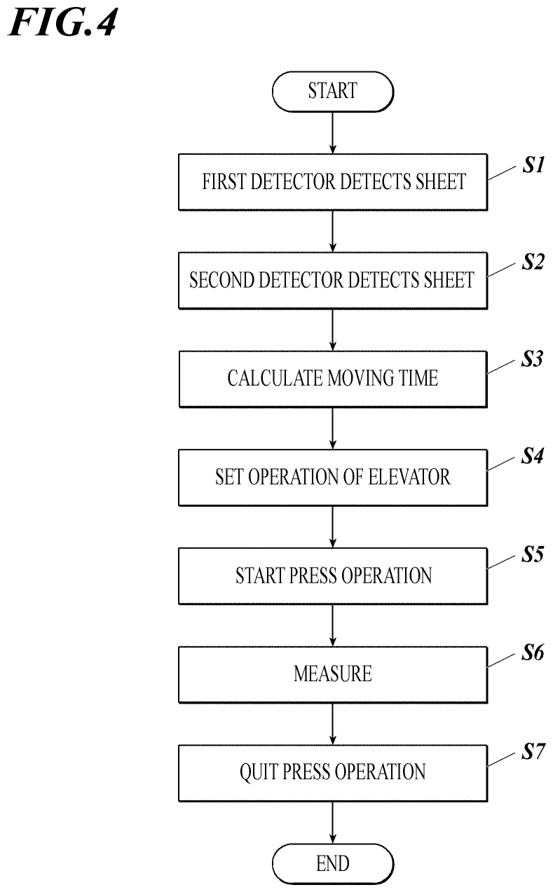

FIG. 4 is a flowchart showing the sheet distinction processing.

The sheet distinction processing is started when a user inserts a sheet P into the slot 102 of the sheet distinction device 100.

A sheet P is, for example, paper or a resin plate. Paper may be rough paper having a surface of coarse paper fiber, plain paper commonly used, high-quality paper having a surface with fine roughness, coated paper having a surface covered with a coating layer, or the like. Sheets are different in surface condition (surface smoothness), thickness, basis weight, etc. The sheet distinction device 100 determines a type of sheet P based on optical information such as an amount of light received by the light receivers 32 after reflected from the sheet P.

First, a user inserts a sheet P into the slot 102 of the sheet distinction device 100. The first detector 10 detects that the sheet P passes by a predetermined position. Detection signal is output to the controller 51 (Step S1).

Next, the user inserts the sheet P deeper into the slot 102. The second detector 20 detects that the sheet P has reached a detection position. Detection signal is output to the controller 51 (Step S2).

Next, as an information value that indicates time taken to insert the sheet P from the predetermined position to the detection position of the slot 102, the controller 51 calculates moving time of the sheet P from the predetermined position to the detection position based on difference in output time of the detection signal between the first detector 10 and the second detector 20 (Step S3).

As the information value that indicates the time taken to insert the sheet P from the predetermined position to the detection position of the slot 102, the controller 51 may calculate moving speed of the sheet P from the predetermined position to the detection position.

Next, the controller 51 sets operation start time and operation speed of the elevator 42 based on the calculated moving time (Step S4).

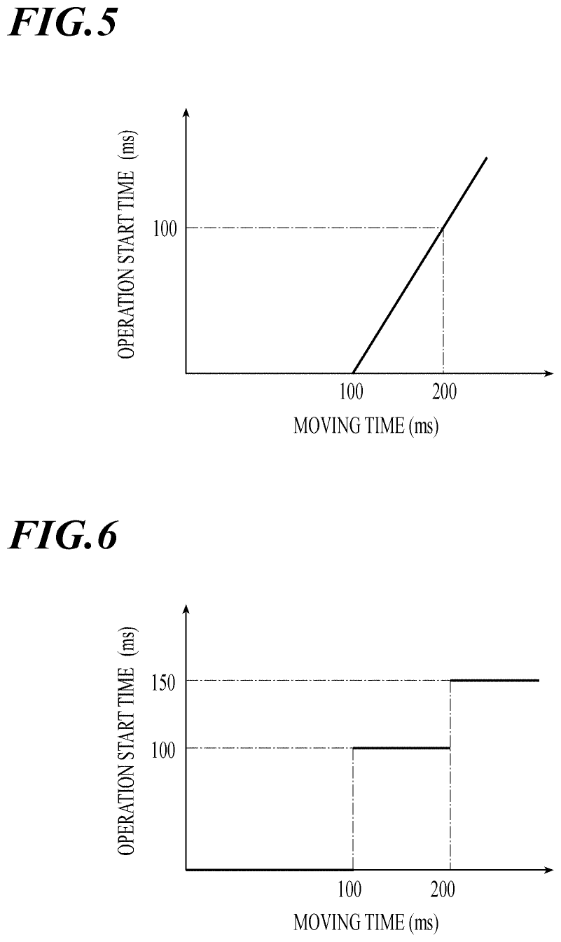

Specifically, the controller 51 sets the operation start time in accordance with the calculated moving time using a predetermined arithmetic formula, for example, as shown in FIG. 5. Similarly, the controller 51 also sets the operation speed in accordance with the calculated moving time using a predetermined arithmetic formula. Arithmetic formulae are stored in advance in the memory 52.

The operation start time is based on, for example, time when the second detector 20 detects the sheet P after the first detector 10 detects the sheet P. The shorter the moving time of the sheet P, the earlier the operation start time. In other words, the shorter the moving time of the sheet P, the shorter the time length from the time when the second detector detects the sheet P to the time when the elevator 42 starts operation.

Also, the shorter the moving time of the sheet P, the faster the operation speed (rising speed and falling speed) of the support plate 41 operated by the elevator 42.

Alternatively, in accordance with the calculated moving time, the controller 51 may set the operation start time based on setting information that includes various levels of thresholds of moving time together with an operation start time for each threshold, for example, as shown in FIG. 6. The controller 51 may also set the operation speed in accordance with the calculated moving time in the same manner. Also in this case, the setting information is stored in advance in the memory 52.

The operation start time is based on, for example, time when the second detector 20 detects the sheet P after the first detector 10 detects the sheet P.

A stepwise earlier operation start time is set for a shorter moving time. A stepwise shorter time length from the time when the second detector 20 detects the sheet P to the time when the elevator 42 starts operation is set for a shorter moving time. Also, a stepwise faster operation speed (rising speed and falling speed) of the support plate 41 operated by the elevator 42 is set for a shorter moving time.

Next, the controller 51 makes the elevator 42 raise the support plate 41 at the operation start time and the operation speed that are set in Step S4. The sheet P is pressed against the housing 33 of the measurer 30 (Step S5).

Thus the sheet P is fixed.

Next, the controller 51 makes the measurer 30 perform measurement (Step S6).

Specifically, the controller 51 makes the light emitter 31 emit light to the sheet P The light receivers 32 receive light reflected from the sheet P. The type of sheet P is determined from optical information such as an amount of light reflected from the sheet P.

Next, the controller 51 makes the elevator 42 lower the support plate 41 at the operation speed set in Step S4 to quit the press operation for the sheet P against the housing 33 (Step S7). Thus the processing ends.

Then the user pulls the sheet P out of the slot 102, and the entire processing ends. The display 54 displays the type of the sheet P.

### ADVANTAGEOUS EFFECT OF EMBODIMENT

As described above, the sheet distinction device 100 according to the embodiment includes:

the slot 102 into which the sheet P is inserted;

the detector (the first detector 10 and the second detector 20) that detects that the sheet P has reached the detection position of the slot 102;

the presser (the support plate 41 and the elevator 42) that moves the sheet P, which has reached the detection position of the slot 102 and has been detected by the detector, in a direction perpendicular to the insertion direction of the sheet P to press the surface of the sheet P against the measurement surface of the measurer 30; and

the measurer 30 that measures physical properties of the sheet P that has reached the detection position of the slot 102.

The controller 51 calculates the information value (the moving time or the moving speed) that indicates the time taken to insert the sheet P from the predetermined position to the detection position of the slot 102. The controller 51 controls the operation start time and the operation speed of the presser in accordance with the calculated information value.

Since the sheet P is fixed during measurement of the physical properties of the sheet P, stable accuracy in measurement is achieved. Also, since the press operation of the presser is controlled in accordance with the moving time or the moving speed of the sheet P, the press operation is performed at a speed in accordance with operation of a user.

Therefore, stable accuracy in measurement is achieved without decreasing work efficiency of a user.

According to the embodiment, the controller 51 controls the presser such that, the shorter the moving time, the earlier the operation start time and the faster the operation speed.

Alternatively, the controller 51 sets the operation start time and the operation speed of the presser based on various levels of predetermined thresholds of moving time, such that earlier operation start time and faster operation speed are set for a smaller threshold.

If the moving time of the sheet P is short, it is assumed that a user wishes quick processing. Then the press operation is quickly performed. If the moving time of the sheet P is long, it is assumed that a user wishes steady processing. Then the press operation is delayed.

It achieves operation suitable for users.

The detector according to the embodiment includes the first detector 10 and the second detector 20. In the direction of inserting the sheet P into the slot 102, the first detector 10 is upstream from the measurer 30 while the second detector 20 is downstream from the measurer 30. The controller 51 calculates the moving time or the moving speed of the sheet P from the difference in detected time between the first detector 10 and the second detector 20.

Thus, the moving time or the moving speed of the sheet P is calculated from detected signals of the first detector 10 and the second detector 20.

The controller 51 according to the embodiment sets the operation start time of the presser based on the time when the second detector 20 detects the sheet P after the first detector 10 detects the sheet P.

Time is counted until the press operation is started from the time when the second detector 20 detects the sheet P after the first detector 10 and the second detector 20 normally detect the sheet P. Thus accuracy in measurement is maintained while the press operation is started earliest.

Embodiments of the present invention are not limited to the embodiments described above. Various modifications are possible within the scope of the present invention.

For example, the controller 51 may set at least one of the operation start time and the operation speed of the presser at a fixed value in response to operation by a user.

This achieves press operation that meets users' preference.

The controller 51 may not make the presser perform the press operation if the difference in the detected time between the first detector 10 and the second detector 20 deviates from a predetermined normal range.

Measurement is not performed for abnormal insertion.

In the above embodiment, the moving time or the moving speed is calculated using the first detector 10 and the second detector 20. Alternatively, a separate detector for detecting them may be provided in addition to the first detector 10 and the second detector 20.

For example, a thickness detector that detects thickness of a sheet P may be provided. The controller converts width of a pulse signal into the moving speed of the sheet P, the pulse

1. A sheet distinction device comprising:
a slot into which a sheet is inserted;
a detector that detects that the sheet has reached a detection position of the slot;
a measurer that measures physical properties of the sheet that has reached the detection position of the slot;
a presser that moves the sheet in a direction perpendicular to an insertion direction of the sheet to press a surface of the sheet against a measurement surface of the measurer after the detector detects that the sheet has reached the detection position of the slot;
a calculator that calculates an information value indicating time taken to insert the sheet from a predetermined position of the slot to the detection position; and
an operation controller that controls operation start time and operation speed of the presser in accordance with the information value calculated by the calculator.

2. The sheet distinction device according to claim 1, wherein the operation controller controls the presser in accordance with the information value calculated by the calculator such that, the shorter the time taken to insert the sheet from the predetermined position to the detection position, the earlier the operation start time and the faster the operation speed of the presser.

3. The sheet distinction device according to claim 1, wherein, in accordance with the information value calculated by the calculator, the operation controller sets the operation start time and the operation speed of the presser based on various levels of predetermined thresholds of the time taken to insert the sheet from the predetermined position to the detection position, such that earlier operation start time and faster operation speed are set for a smaller threshold.

4. The sheet distinction device according to claim 1, wherein the operation controller is capable of setting at least one of the operation start time and the operation speed of the presser at a fixed value in response to operation by a user.

5. The sheet distinction device according to claim 1, wherein
the detector comprises a first detector and a second detector respectively aligned upstream and downstream from the measurer in the insertion direction of the sheet into the slot, and
the calculator calculates, as the information value, the moving time or the moving speed of the sheet from the predetermined position to the detection position based on difference in detected time between the first detector and the second detector.

6. The sheet distinction device according to claim 5, wherein, in a case in which the moving time or the moving speed calculated from the difference in the detected time between the first detector and the second detector deviates from a predetermined normal range, the operation controller does not make the presser press perform pressing.

7. The sheet distinction device according to claim 5, wherein the operation controller sets the operation start time of the presser based on time when the second detector detects the sheet after the first detector detects the sheet.

8. The sheet distinction device according to claim 1, further comprising:
a thickness detector that detects thickness of the sheet,
wherein the calculator calculates the information value by converting width of a pulse signal into the moving speed of the sheet from the predetermined position to the detection position, the pulse signal corresponding to the thickness output by the thickness detector.

9. The sheet distinction device according to claim 1, further comprising:
a speed detector that detects moving speed of the sheet,
wherein, as the information value, the calculator calculates moving speed of the sheet from the predetermined position to the detection position based on a value output by the speed detector.

10. An image forming apparatus comprising the sheet distinction device according to claim 1.
